(19) United States
(12) Patent Application Publication
(10) Pub. No.: US 2015/0047405 A1
(43) Pub. Date: Feb. 19, 2015

(54) Methods and Systems for Extrusion

(71) Applicant: Mississippi State University, Mississippi, MS (US)

(72) Inventors: Stephen Horstemeyer, Starkville, MS (US); Paul Wang, Starkville, MS (US); Mark Horstemeyer, Starkville, MS (US); Robert Malley, Starkville, MS (US); Esteban Marin, Hickory, NC (US)

(21) Appl. No.: 14/462,543

(22) Filed: Aug. 18, 2014

Related U.S. Application Data
(60) Provisional application No. 61/866,963, filed on Aug. 16, 2013.

(51) Int. Cl. B21C 23/21; B21C 29/00; B21C 25/00; B29C 47/00; B29C 47/80

(52) U.S. Cl. CPC B21C 23/212; B29C 47/00; B29C 47/802; B21C 25/00; B21C 29/003
USPC 72/253.1; 425/376.1; 264/176.1

(57) ABSTRACT

The presently-disclosed subject matter relates to an apparatus and methods for extruding a material. Embodiments of the apparatus comprise a chamber that includes an opening that faces at least a downstream side of the chamber, a die slideably received by the opening that includes a channel that is in fluid communication with the chamber, and a base portion that includes a fixture, the fixture being annular and configured to couple to a downstream side of the die. Embodiments of methods for extruding the material can include providing the apparatus, placing a material in an original state within the opening of the chamber, applying a force to an upstream side of the chamber to thereby push the material through the channel of the die, and collecting the material in a modified state downstream of the fixture.

### RELATED APPLICATIONS

This application claims priority from U.S. Provisional Patent Application No. 61/866,963, filed Aug. 16, 2014, the entire disclosure of which is incorporated herein by this reference.

### GOVERNMENT INTEREST

This invention was made with government support under Grant Number DE-FC26-06NT42755 awarded by the U.S. Department of Energy. The government has certain rights in the invention.

### TECHNICAL FIELD

The presently-disclosed subject matter relates to an extrusion apparatus. In particular, the presently-disclosed subject matter relates to an apparatus that can be used for indirect extrusion processes.

### INTRODUCTION

Metal extrusion generally refers to a process whereby a metal is formed into a particular shape by forcing the metal through an die. Extrusion is a metal press forming process that includes inserting a billet with a pre-defined length into a high temperature chamber and extruding the material by a movement of a ram or a die. Direct extrusion refers to an extrusion processes wherein the ram moves while the rest of the chamber and the die are stationary. Indirect extrusion refers to an extrusion processes wherein the die or the die and the chamber move together while the rest of the system remains stationary. The shape and length of metal billet are changed from an original state to a modified state depending on the shape of channel(s) in the die.

For instance, some known extrusion processes are capable of processing metal, such as aluminum and magnesium, into elongated shapes. Aluminum is desirable for certain applications given its low density and corrosion resistant properties. Consequently, extruded aluminum is commonly used in the aerospace, transportation, and other industries in which weight and/or corrosion resistance are required. Similarly, magnesium is another metal that is desirable for certain applications. Magnesium can be about 35% lighter than aluminum and about 75% lighter than steel. Magnesium also has favorable mechanical properties, including good strength, thermal conductivity, stiffness, and the like.

However, the development and installation of extrusion systems can be costly and time consuming. Among other things, this is due to the fact that there are no known systems that can be rapidly and efficiently reconfigured in order to analyze various different potential extruder designs. Therefore, it can be difficult to design extrusion systems without considerable investments of time, money, and resources.

Hence, there remains a need for extrusion systems and methods that are cost and time effective. Likewise, there remains a need for extrusion systems and methods that can facilitate the design and installation of new extrusion systems.

### SUMMARY

The presently-disclosed subject matter meets some or all of the above-identified needs, as will become evident to those of ordinary skill in the art after a study of information provided in this document.

This Summary describes several embodiments of the presently-disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this Summary or not. To avoid excessive repetition, this Summary does not list or suggest all possible combinations of such features.

The presently-disclosed subject matter includes an apparatus for extruding materials. In some instances the material is selected from a metal, a polymer, and combinations thereof. In some embodiments the apparatus comprises a chamber that includes an opening that faces at least a downstream side of the chamber, the opening having a size corresponding to the material in an original state, a die downstream of the chamber that is slideably received by the opening of the chamber, the die including a channel that is substantially in fluid communication with the opening of the chamber, and a base portion that includes a fixture, the fixture being annular and configured to couple to a downstream side of the die. In some embodiments the base portion further comprises a weld chamber that is in fluid communication with the channel of the die, wherein an upstream side of the weld chamber is configured to couple to a downstream side of the fixture. In some embodiments the weld chamber includes one or more windows on side thereof that communicate between an exterior side and an interior side of the weld chamber. In further embodiments the fixture is integral with the weld chamber.

In some embodiments the die comprises a splitter, the splitter including one or more webs that define two or more channels. The splitter can be disposed on an upstream side of the die. In some embodiments the splitter includes a center obstruction and a peripheral ring, wherein the one or more webs radially extend from the center obstruction to the peripheral ring.

In some embodiments an upstream side of the die includes a surface that slopes in the direction of the channel.

In some embodiments the chamber is comprised of two or more separate elements. For example, a chamber can be comprised of a first housing and a second housing, wherein the first housing is upstream of the second housing. The chamber can further comprise a plug configured to be received at least by the first housing, wherein a downstream side of the plug can optionally include an indent (cavity) that corresponds in shape to the material. Furthermore, in some embodiments the chamber also includes a sleeve that is annular, an exterior surface of the sleeve corresponding to an interior surface of the second housing, and an interior surface of the sleeve defining the opening of the chamber.

In some embodiments the apparatus for extruding a material comprises a chamber that includes an opening, which faces at least a downstream side of the chamber, for receiving the material in an original state. In some embodiments the chamber includes a first housing and a second housing that is disposed downstream of the first chamber, a plug configured to be received at least by the first housing, a sleeve that is annular and configured to move axially at least within the second chamber, and a clamp for coupling the first chamber and the second chamber. The embodied apparatus can also comprise a die that is downstream and slideably received by the opening of the chamber, a base portion that includes a fixture, the fixture being annular and configured to couple to a downstream side of the die, and a channel that continuously extends from the opening of the chamber and through the die and the fixture.

The presently-disclosed subject matter also provides methods for extruding a material. Exemplary methods for extruding a material can comprise providing an apparatus that includes a chamber comprising an opening faces at least a downstream side of the chamber, the opening having a size corresponding to the material in an original state, a die that is downstream of the chamber and slideably received by the opening of the chamber, the die including a channel that is in fluid communication with the opening of the chamber, and a base portion that includes a fixture, the fixture being annular and configured to couple to a downstream side of the die; placing a material in an original state within the opening of the chamber and upstream of the die; applying a force to an upstream side of the chamber to thereby push the material through the channel of the die; and collecting the material in a modified state downstream of the fixture.

In some embodiments the methods further comprise, before the applying step, thermally soaking the material in the original state to a soaking temperature corresponding to about 50% to about 99% of a melting temperature of the material, and in some embodiments to a soaking temperature corresponding to about 70% to about 90% of the melting temperature of the material. In some embodiments the thermal soaking step can be about 0.5 hours to about 3.0 hours in duration.

In some embodiments a longitudinal axis of the apparatus is oriented in an vertical position during the extrusion process.

### BRIEF DESCRIPTION OF THE DRAWINGS

FIG. 1 shows a perspective view of an extrusion apparatus in accordance with an embodiment of the presently-disclosed subject matter.

FIG. 2 shows an exploded view of the embodiment of the extrusion apparatus.

FIG. 3 shows a perspective view of the embodiment of the extrusion apparatus that has been cut along its longitudinal axis.

FIG. 4 shows an cross-sectional view of the embodiment of the extrusion apparatus that has been cut along its longitudinal axis.

FIG. 5 shows a top view of a chamber in accordance with an embodiment of the presently-disclosed subject matter.

FIG. 6 shows a side view of a portion of the chamber.

FIG. 7 shows a side view of a chamber in accordance with another embodiment of the presently-disclosed subject matter.

FIG. 8 shows a cross-sectional view of a die in accordance with an embodiment of the presently-disclosed subject matter.

FIG. 9 shows a cross-sectional view of a fixture in accordance with an embodiment of the presently-disclosed subject matter.

FIG. 10 shows a top view of a splitter in accordance with an embodiment of the presently-disclosed subject matter.

FIG. 11 shows a bottom view of the splitter shown in FIG. 10.

FIG. 12 shows a cross-sectional view of a chamber coupled to a die that includes a splitter.

FIG. 13 shows a top view of a splitter in accordance with another embodiment of the presently-disclosed subject matter.

FIG. 14 shows a bottom view of the splitter shown in FIG. 13.

FIG. 15 shows a perspective view of a lower die portion in accordance with an embodiment of the presently-disclosed subject matter.

FIG. 16 shows a top view of a splitter in accordance with another embodiment of the presently-disclosed subject matter.

FIG. 17 shows a cross-sectional view of an upstream side of a die that has two thermocouples.

FIG. 18 shows a graph of temperature rise and soak time collected by two thermocouples in the second (bottom) chamber.

FIG. 19 shows a graph of load, extension, and time for magnesium AZ61 extruded at 50% extension, 5 mm/min, and 850/454.

FIG. 20 shows an image of a welded aluminum extrudate.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

The presently-disclosed subject matter includes apparatuses for extruding materials. In some embodiments the materials include polymers or metals, such as lightweight metals or alloys thereof. In some embodiments the metals are selected from aluminum, magnesium, and the like. In some instances the extruding apparatuses permit quick and efficient interchangeability of apparatus' configuration, thereby permitting relatively inexpensive and rapid testing of different extrusion configurations.

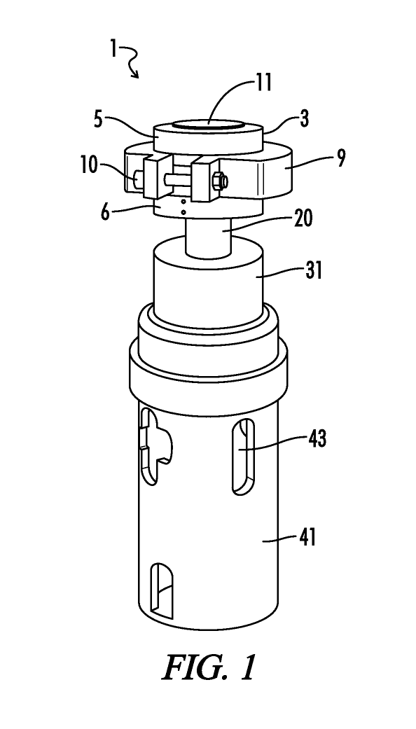

Turning now to the Figures, various view of exemplary embodiments of extrusion apparatuses are shown. FIG. 1 shows a perspective view of an extrusion apparatus 1 in accordance with an embodiment of the presently disclosed subject matter. As used herein, the terms upstream and downstream refer to a direction in which the material moves during an extrusion process. In particular, a material will move from the upstream side toward the downstream side of the apparatus during an extrusion process. With reference to FIG. 1, an upstream side refers to a top or upward side and a downstream side refers to a bottom or downward side.

The apparatus 1 shown in FIG. 1 comprises, from an upstream side to a downstream side of the apparatus 1, a chamber 3, a die 20, a fixture 31, and a weld chamber 41. The chamber 3 itself is comprised of multiple distinct pieces, including a first (top) housing 5, a second (bottom) housing 6, and a clamp 9 that couples the first housing 5 to the second housing 6. The clamp 9 is actuated by a bolt 10 that can be screwed to tighten the clamp 9. Although the depicted embodiment includes a clamp 9 and bolt 10 for coupling the first housing 5 and the second housing 6, the coupling means are not particularly limited. FIG. 7 shows another non-limiting embodiment of a chamber 3, wherein a clamp 9 is provided that is engaged by two longitudinally oriented bolts 10. In this manner, tightening the bolts 10 pulls the first housing 5 and the second housing 6 together.

In the embodied apparatus 1 both the first housing 5 and the second housing 6 are annular. A plug 11 is provided within at least the first housing 5 so that a top of the chamber 3 forms a flat surface.

A die is provided 20 downstream of the chamber 3. The die 20 is configured to be slideably received by an opening 4 provided on a downstream side of the chamber 3. More specifically, in embodiments wherein the second housing 6 is annular, and the interior of the second housing 6 defines the opening 4 that can slideably receive the die 20.

A base portion is provided 40 downstream of the die 20. The base portion is comprised of a fixture 31. An upstream side of the fixture 31 includes a die seat 33 that can receive a downstream side of the die 20. Thus, by placing the die 20 within the die seat 33, the die 20 and the fixture 31 can couple and form one continuous element. As shown in other figures provided herein, in some embodiments the die seat 33 includes an indent that is provided on an upstream side of the fixture 31 and that corresponds in shape to the downstream side of the die 20. For instance, FIG. 9 shows a cross sectional view of the embodied fixture 31. The die seat 33 is provided on the upstream side of the fixture 31. The die seat 33 is comprised of an indentation in the fixture 31 that corresponds in shape to the die 20.

Further still, the exemplary apparatus 1 includes an optional weld chamber 41 that forms a portion of the base portion 40. The weld chamber 41 can provide an area for an extrudate to collect, and in some instances provides space in a furnace to allow an extruded product to exit the die 20 and be cut into desired dimensions. Conditions within the weld chamber 41 can also be adjusted by a user to expose the extrudate to particular temperatures, gasses, and the like. Windows 43 can be provided on a side of the weld chamber 41 and can permit observation and/or collection of the extrudate, wherein the windows 43 define openings that communicate between an exterior side and an interior side of the weld chamber 41.

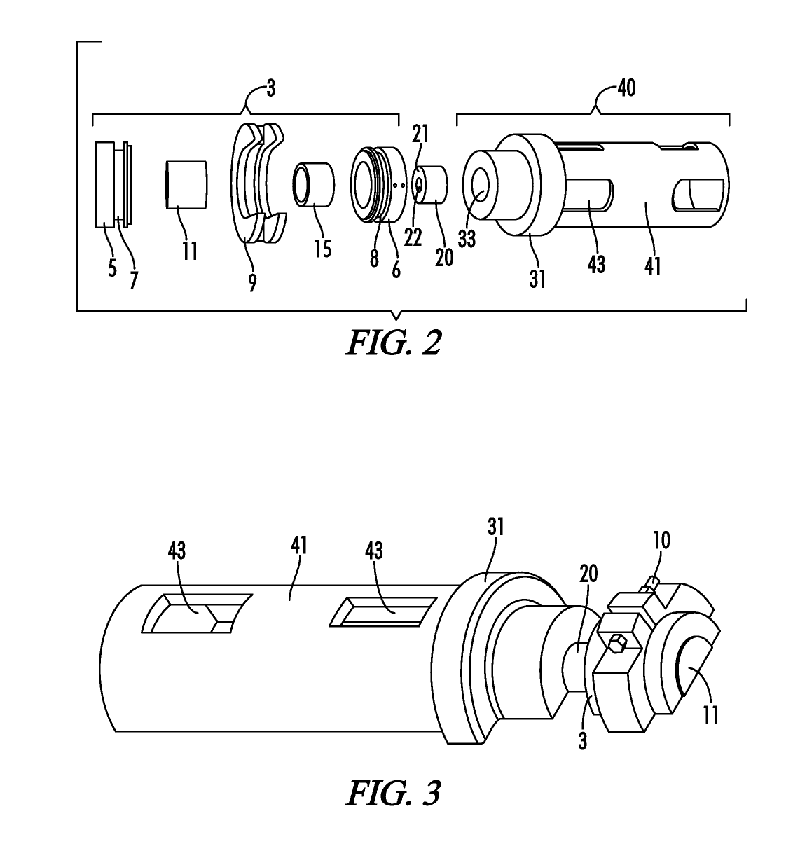

Looking now to FIG. 2, an exploded view of the apparatus 1 is shown. FIG. 2 shows the various elements of the apparatus 1, including the chamber 3, the die 20, and the base portion 40. The depicted chamber 3 is comprised of the first housing 5, a plug 11, a clamp 9, a sleeve 15, and the second housing 6. The sleeve 15 is cylindrical and shaped so that it can be slideably received at least by the second housing 6. The sleeve 15 is also annular, and the interior side of the sleeve 15 defines the opening of the chamber 4. The interior side of the sleeve 15 can therefore be shaped so as to correspond to a shape of a billet 50 material in an original state (e.g., cylindrical metal billet). In other embodiments an apparatus 1 can comprise two or more sleeves, optionally disposed between each of the aforementioned components.

FIG. 2 illustrates that the first housing 5 and the second housing 6 include, respectively, a first groove 7 and a second groove 8. When the first housing 5 and the second housing 6 are in close proximity or touching, the clamp 9 can engage each of the first groove 7 and the second groove 8 to couple the housings and form the chamber 3.

Chambers 3 that are comprised of a plurality of elements can facilitate disassembly and modification of the extrusion apparatus 1. For instance, if a surface of the sleeve 15 is compromised, the sleeve 15 can be interchanged without requiring replacement of the entire chamber 3. Sleeves 15 of different sizes can also be provided for different sized billets 50 so that a single apparatus 50 may be used to extrude different sized billets 50. Furthermore, in order to avoid welding and alloying of the different elements, the sleeve 15 material can be selected so that it differs from a material of the second chamber 6 and a material of the billet 50.

Likewise, embodiments of multi-component extrusion apparatuses 1 having a clamp 9 can be disassembled by opening the clamp 9. Once disassembled, one can configure the apparatus 1 by interchanging the components of the apparatus 1. One can thus modify or interchange the die 20 and/or extrusion apparatus 1 configuration so that the material being extruded exits the die 20 so as to meet a specific profile of a product. Since the interchangeability can be relatively efficient and quick, embodiments of the present extrusion apparatus 1 permit the die 20 to be redesigned and reproduced without requiring a new fixture assembly.

Embodiments of the present apparatuses also have the benefit of being capable of being configured as laboratory-scale or small-scale systems. Such apparatuses and systems can provide a novel set of data to create process-structure-property relationships, including for lightweight alloys such as aluminum and magnesium, under extremely large deformation at elevated temperature conditions. Thus, no matter the scale of the apparatuses and systems, the presently-disclosed subject matter can provide apparatuses and systems for experimental extrusion configurations that characterize certain materials, processes, extruder assemblies, or the like. This can be particularly so for small or laboratory-scale implantations, which can be more cost and time effective to run and reconfigure. Furthermore, even if small or laboratory scale implementations are utilized, the processing parameters, process structure, and other data obtained for such systems and methods can be transferred to scale-up operations for industrial extrusion systems and methods.

Those of ordinary skill will appreciate that a chamber 3 can be comprised of fewer or more elements than those depicted in FIG. 2. For example, in some embodiments the first housing 5 and the plug 11 can be one integral element. In other embodiments the second housing 6 and the sleeve 15 can be one integral element. In yet further embodiments the clamp can be comprised of a single element having an opening 4 on a downstream side thereof for receiving a billet 50.

FIG. 2 also illustrates that the die includes an upstream side 21 that is configured to be pressed against a billet 50. As described further below, as the billet 50 is pressed into the upstream side 21 of the die 20, the billet 50 is pushed through a bearing 22 that defines the opening(s) of the die 20.

In FIG. 2 the base portion 40 is also comprised of multiple elements, and specifically is comprised of a fixture 31 and a weld chamber 41. FIG. 2 shows the die seat 33 provided on an upstream side of the fixture 31 that corresponds in shape to the die 20. Similar to the chamber 3, in other embodiments the base portion 40 can be comprised of one element or three or more elements. For example, the fixture 31 and the weld chamber 40 are separate elements in some embodiments, and other embodiments the fixture 31 and the weld chamber 40 together comprise one element.

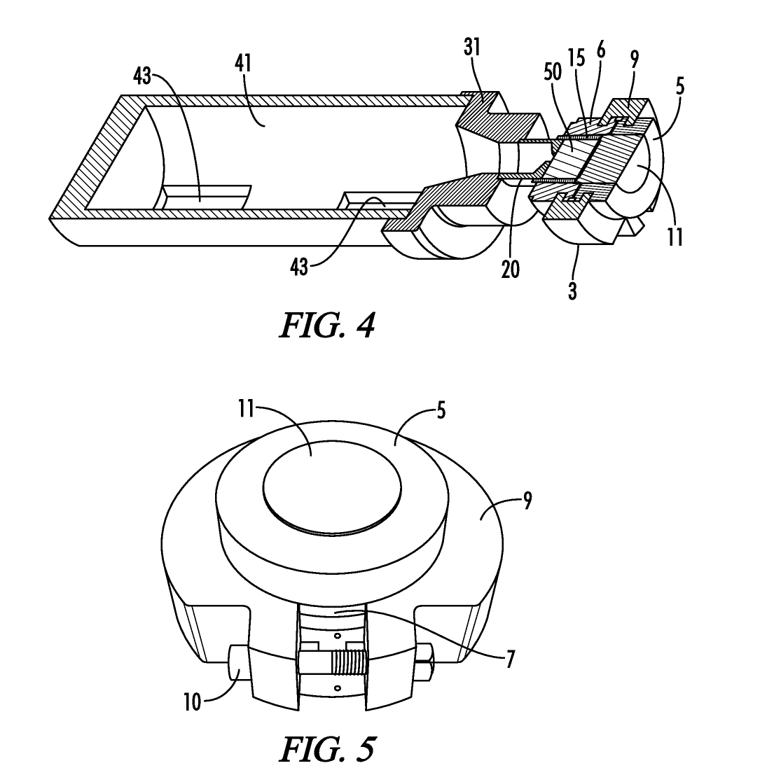

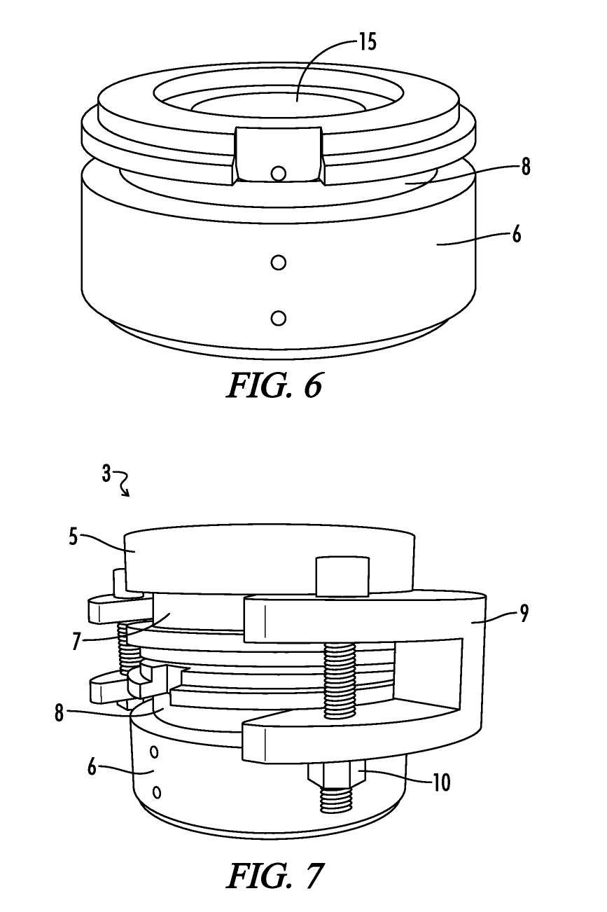

A cross-sectional view of the embodied apparatus 1 is shown in FIG. 4. FIG. 4 shows that an exterior side of the sleeve 15 corresponds to the interior side of the second housing 6, whereas the interior side of the sleeve 15 corresponds to the exterior side of the billet 50 as well as the exterior side of the die 20. Accordingly, when a force is applied to an upstream side of the chamber 3, the billet 50 is pushed through the die 20 via the bearing 22. FIG. 4 also illustrates that the chamber 3, the die 20, and the base portion 40 (comprised of fixture 31 and weld chamber 41) are in fluid communication so that the billet can move from within the chamber 3, through the die 20, and into the weld chamber 41 during an extrusion process.

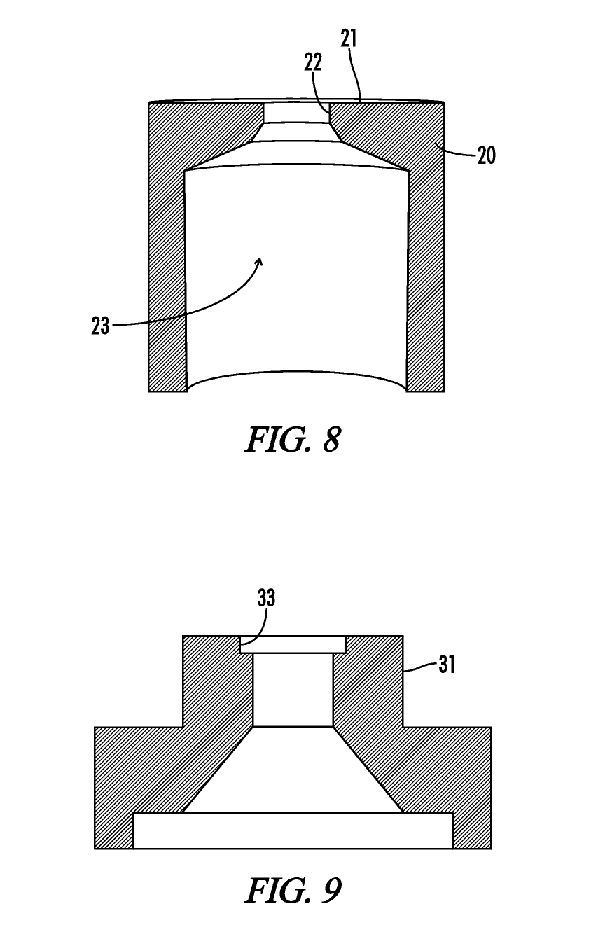

In this regard, and looking now to FIG. 8, a cross-sectional view of the die 20 is shown that illustrates the bearing 22 provided in the upstream side of the die 21. The bearing 22 itself corresponds to the smallest opening of a channel 23, wherein the channel 23 that longitudinally traverses the entire die 20. The bearing 22 therefore defines the shape of the extrudate since it represents the area where the extrudate is most compressed during an extrusion process. The bearing 22 shown in FIG. 8 is the smallest diameter portion of the cylindrical channel 23 that traverses the die 20.

As described above, the downstream side of the die 20 can be coupled to the fixture via a die seat 33. FIG. 9 shows a cross sectional view of the embodied fixture 31. The die seat 33 is provided on the upstream side of the fixture 31. The die seat 33 is comprised of an indentation in the fixture 31 that corresponds in shape to the die 20. The bottom of the die seat 33 includes a lip for securing the die 20 in the longitudinal direction.

The design of the dies 20 is not particularly limited, and may be altered in various embodiments. Indeed, exemplary dies 20 can have one or more bearings 22 of various shapes and sizes that yield desired extrudates. In some embodiments the dies comprise two or more bearings 22, and therefore the extrudate includes two or more streams of the material flowing from the die 20. Dies are not limited to dies that produce extruded product having a circular or oval outer profile. Instead, dies can be configured so that the extruded product can be flat, square, triangular, or another irregular shape or pattern. It will be appreciated by those in the art that dies can be configured to have a multitude of shapes and dimensions.

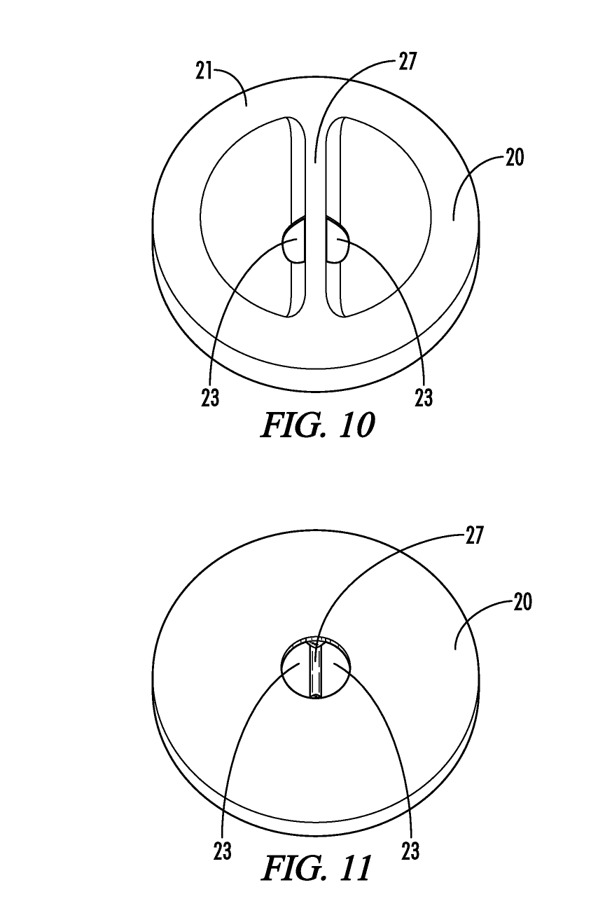

For example, FIGS. 10 and 11 show an exemplary die 20 that can be characterized as a splitter. The term “splitter” is used herein to refer to a die 20 and/or a die component that splits a billet 50 into two or more streams. The two or more streams of extrudate can optionally be welded together downstream of the die 20. FIGS. 10 and 11 show a splitter that includes one web 27, wherein the web 27 is comprised of an elongated narrow obstruction that traverses the bearing 22 in order to define two separate channels 23. The splitter in FIGS. 10 and 11 is configured to be a component of a die.

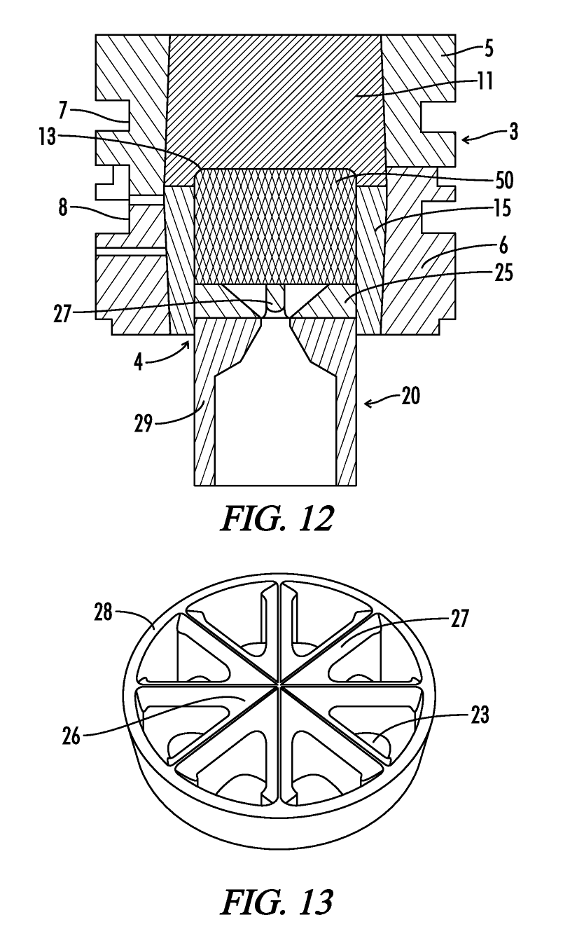

Specifically, FIG. 12 shows a cross-sectional view of a die 20 and a chamber 3. The chamber 3 is comprised of a first housing 5, a second housing 6, a plug 11, and a sleeve 9. Furthermore, the die 20 is comprised of a upper die portion 25 that is a splitter and a lower die portion 29 that is disposed downstream of the upper die portion 25. The lower die portion 29 serves as a support for the supper die portion 25, although it has a similar shape and function as other embodiments of dies that are described herein. Additionally, FIG. 12 shows that the billet 50 in its original state is disposed within the chamber 3 on an upstream side of the upper die portion 25. The billet 50 within the chamber 3 is received by the sleeve 15 as well as an indent 13 provided on a downstream side of the plug 11, the indent 13 corresponding in shape to the billet 50. When the chamber 3 is forced towards the die 20, the die 20 will be slideably received by the chamber 3 opening 4. As the die 20 is received in the chamber 3, the billet 50 is forced through across both sides of a web 27 provided on the upper die portion 25, and then continues through the channel 23 in the die 20 as two split streams of extrudate.

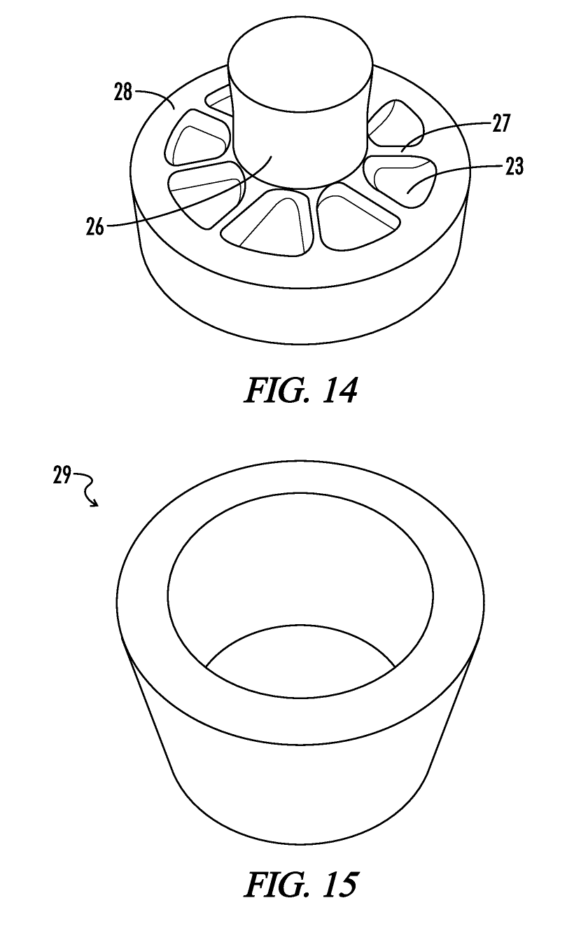

The number of webs 27 and channels 23 on a splitter die 20 are not particularly limited. In some embodiments a splitter die 20 can be configured to have about 2, 3, 4, 5, 6, 7, 8, 9, 10, or more webs and/or channels. For instance, FIGS. 13 and 14 show another exemplary splitter 20 that comprises eight webs 27 that define eight separate channels 23. The splitter also includes an axial center obstruction 26, and the webs 27 extend radially from the center obstruction 26 to a peripheral ring 28.

As shown in FIG. 14, the center obstruction 26 can extend from a downstream side of the splitter. Among other things, a center obstruction 26 that extends downstream of the splitter can maintain the extrudate streams separate, and may help form certain extrudate designs. In some instances an extruded product having a hollow profile is desired, and an elongated center obstruction 26 can block the flow of a material so that the material must pass around the perimeter of the center obstruction 26 to thereby form the hollow profile. In some embodiments wherein the dies 20 have center obstructions 26 that are held in place by one or more webs 27, the resulting extruded product can comprise a hollow profile as well as longitudinal seams.

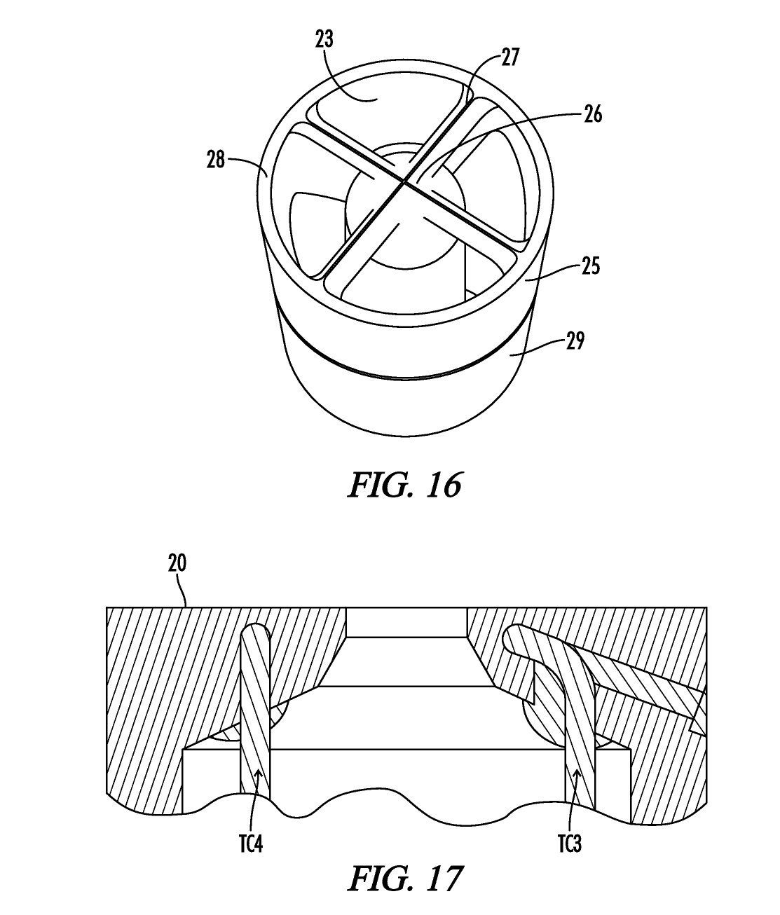

The splitter die 20 of FIGS. 13 and 14 can be a single element that constitutes the die, or the splitter can be a component of a die 20 that includes a plurality of components. For instance, in some embodiments the die 20 includes a splitter that constitutes an upper die portion 25 and an annular lower die portion 29 that can be disposed downstream of the upper die portion 25. In some embodiments the lower die portion 29 is annular and has a shape corresponding to the peripheral ring 28 of a splitter (FIG. 15). FIG. 16 shows an embodiment of a die 20 that includes a upper die portion 25 comprised of a four-channel 23 splitter, and an annular lower die portion 29 that is disposed downstream of the upper die portion 25.

The presently-disclosed subject matter also includes methods for extruding materials. While embodiments of the apparatuses described herein are intended for indirect extrusion, those of ordinary skill in the art will appreciate that the apparatuses or variations thereof can also be used for direct extrusion processes.

In some embodiments the method of extrusion comprises providing an embodiment of the apparatuses described herein, the apparatus comprising a chamber that includes an opening that faces at least a downstream side of the chamber, the opening having a size corresponding to the material in an original state, a die downstream of the chamber that is slideably received by the opening of the chamber, the die including a channel that is in fluid communication with the opening of the chamber, and a base portion that includes a fixture, the fixture being annular and configured to couple to a downstream side of the die. Embodiments of methods for extruding a material further comprise placing a material in an original state within the opening and upstream of the die, applying a force to an upstream side of the chamber to thereby push the material through the channel of the die, and collecting the material in a modified state downstream of the fixture. Furthermore, in some embodiments a step of lubricating the apparatus is provided. The lubricant can be used to facilitate the extrusion step, and exemplary lubricants include graphite or a graphite paste.

The material being extruded will generally conform to the shape of the apparatus, and particularly the die, so that the extrudate exiting the apparatus has a profile that corresponds to a configuration of the die. The resulting extruded product can comprise a solid and/or hollow profile as well as desirable shapes, thicknesses, and mechanical properties. In some embodiments the extruded material is a lightweight metal or metal alloy, including aluminum, magnesium, other metals, or alloys thereof. In other embodiments the material includes one or more polymers. The present extrusion methods can be implemented to produce lightweight products.

In some embodiments methods for extruding a material further comprise a thermal soaking step. The thermal soak step commences prior to at least the step of applying a force to an upstream side of the chamber. The thermal soaking step can heat a bulk material to a temperature that is below the melting point of the particular material. For example, thermal soaking can involve heating the bulk material in a furnace near the extrusion apparatus and/or heating the material in its original state after it has been placed within an extrusion apparatus. For a lightweight material, the soaking temperature can be about 50%, 55%, 60%, 65%, 70%, 75%, 80%, 85%, 90%, or 95% of the bulk material's melting temperature. In some embodiments the soaking temperature corresponds to about 70% to about 90% of the melting temperature of the material. In certain embodiments the thermal soaking step can comprise heating a bulk material to about 100° C., 200° C., 300° C., 400° C., 500° C., 600° C., 700° C., 800° C., 900° C., 1000° C., 1100° C., 1200° C., 1300° C., 1400° C., 1500° C., or any other suitable temperature.

The duration of the thermal soaking step is not particularly limited. In some embodiments thermal soaking is carried out for a time sufficient to achieve a uniform temperature throughout the bulk material and/or the extrusion apparatus. In this regard, in some embodiments thermal soaking is performed for about 0.5 hours, 1.0 hours, 1.5 hours, 2.0 hours, 2.5 hours, or 3.0 hours. Of course, the time that thermal soaking is performed can vary depending on the temperature of the thermal soaking, the desired final temperature, the material being heated, and the dimension of the material being extruded. Thermal soaking can also be performed for a period of time after the temperature of the material being extruded has equilibrated and attained a uniform temperature.

Furthermore, to maintain the integrity of the material prior to extrusion, thermal soaking of lightweight alloys, such as magnesium alloy, can be performed under a noble gas environment and at a particular temperature range that will allow the material to maintain fluidity for the subsequent extrusion. This can minimize the possibility of oxidation happening under high temperature. This can also prevent the material from disintegrating before extrusion due to pre-matured cracking and/or surface cracking during extrusion.

The presently-disclosed subject matter is further illustrated by the following specific but non-limiting examples. The examples may include compilations of data that are representative of data gathered at various times during the course of development and experimentations related to the presently-disclosed subject matter.

### EXAMPLES

### Example 1

This Example describes extrusion processes conducted using embodiments of the presently-disclosed apparatuses. Among other things, this Example characterizes different thermal soaking temperatures during the thermal soaking step and during extrusion.

To characterize the extrudate, thermocouples were introduced into the apparatus. Specifically, three thermocouple holes were drilled into the second (bottom) housing that receives the sleeve. A first thermocouple (TC1) was installed into a hole drilled in the second housing at a midpoint along its longitudinal length. A second thermocouple (TC2) was installed in a hole drilled towards the upstream side of the second housing and on an area that would be covered by a clamp.

Two additional thermocouples (TC3 and TC4) were also added to the die to obtain data of the temperature history at different points in the billet-extrudate during the extrusion procedure. FIG. 17 shows a cross-sectional view of the upstream side of a ¼ inch die that includes a 1/16 inch bearing. The thermocouples were mounted using Omegabond 400 (Omega Engineering, Inc., Stamford, Conn.).

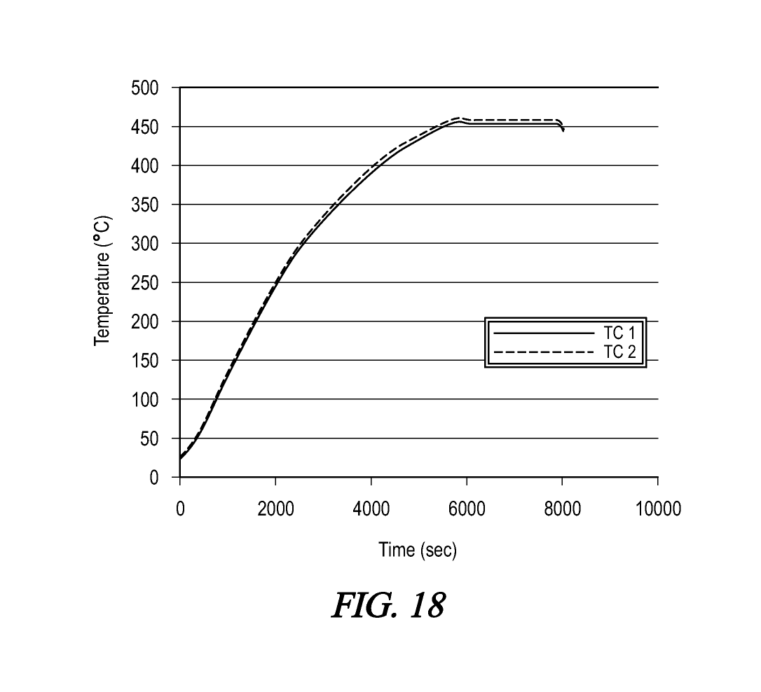

Next, an aluminum 1100 material was heated and then extruded through the apparatus. The bulk material was heated and held to the testing temperature for a period of time. FIG. 18 shows the rise of temperature versus soak time registered by the two thermocouples in the second housing. It took about 2 hours to reach the testing temperature. An additional soaking time of 30 minutes was used to ensure a uniform temperature distribution in the fixture-specimen system.

### Example 2

This Example describes and characterizes extrusion processes conducted using the apparatus described in Example 1.

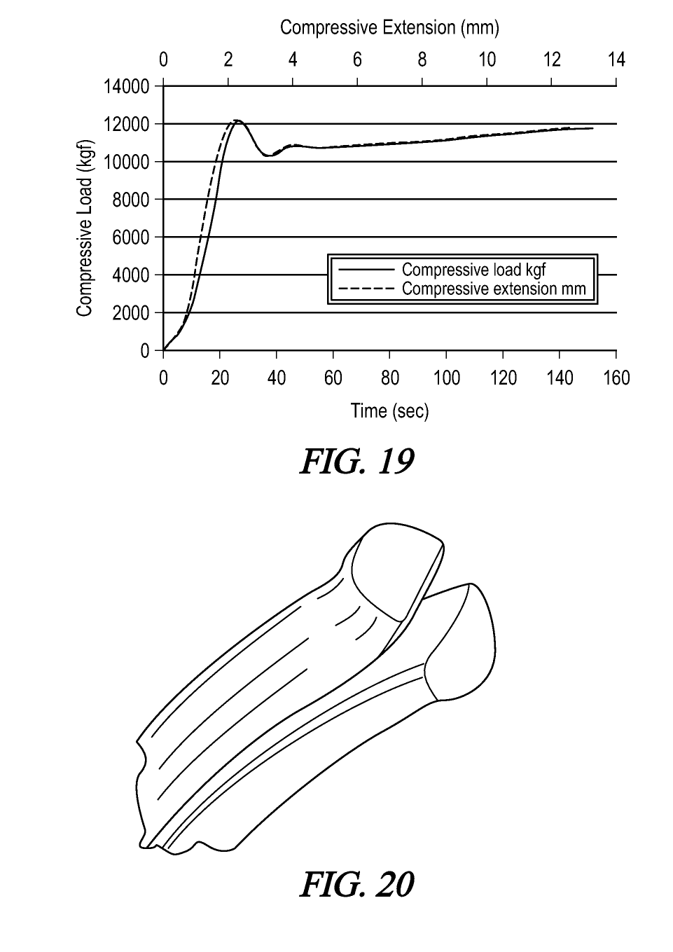

Procedures were conducted to extrude lightweight materials such as aluminum and magnesium, and also to produce weld seams using the above-described two-porthole splitter. For example, 1100F Aluminum and Mg alloys of AM30 and AZ61 were extruded. For instance, FIG. 19 shows the compressive load results for magnesium AZ61 extruded at 5 mm/min through a ¼″ hole, 1/16″ bearing, and 850F/454C (ID#5010), while the temperature evolution is shown in FIG. 20.

### Example 3

This Example describes and characterizes extrusion of material with a splitter die. Specifically, the solid-state bonding process that occurs in splitter dies of hollow Mg extrusions will be examined by using a splitter placed between the chamber and the die (lower die portion). The splitter includes one web that splits the flow into two channels. The rear end of the web has a butt-ended shape that is apart 1/16″ from the bearing. The extrudate should include an elongated profile with an extrusion seam in the middle.

Initial extrusion procedures were conducted using the splitter and 1100F Aluminum. Processing conditions were 300° C., 5 mm/min, and extrusion ratio of 25. FIG. 20 shows the beginning of the extrudate where the two-welded metals streams are clearly noticed. It shows the unsteady state at the beginning part of the weld where the two metal flows separated. The extrudate shows a groove due to the particular splitter design.

Although any methods, devices, and materials similar or equivalent to those described herein can be used in the practice or testing of the presently-disclosed subject matter, representative methods, devices, and materials are described herein.

Following long-standing patent law convention, the terms “a”, “an”, and “the” refer to “one or more” when used in this application, including the claims. Thus, for example, reference to “a die” includes a plurality of such dies, and so forth.

The terms “comprising”, “including,” and “having” are intended to be inclusive and mean that there may be additional elements other than the listed elements.

Unless otherwise indicated, all numbers used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter. It is also understood that each unit between two particular units are also disclosed. For example, if 10 and 15 are disclosed, then 11, 12, 13, and 14 are also disclosed.

As used herein, the term “about,” when referring to a value or to an amount of mass, weight, time, volume, concentration or percentage is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

### LIST OF NUMBERED ELEMENTS

1—extrusion apparatus

3—chamber

4—opening

5—first (top) housing

6—second (bottom) housing

7—first groove

8—second groove

9—clamp

10—screw

11—plug

13—indent

15—sleeve

20—die

21—upstream side of die

22—bearing

23—channel

25—upper die portion

26—center obstruction

27—web

28—peripheral ring

29—lower die portion

31—fixture

33—die seat

40—base portion

41—weld chamber

43—window

50—billet

What is claimed is:

1. A apparatus for extruding a material, comprising:
a chamber that includes an opening that faces at least a downstream side of the chamber, the opening having a size corresponding to the material in an original state;
a die downstream of the chamber that is slideably received by the opening of the chamber, the die including a channel that is in fluid communication with the opening of chamber; and
a base portion that includes a fixture, the fixture being annular and configured to couple to a downstream side of the die.

2. The apparatus of claim 1, wherein the base portion further comprises a weld chamber that is in fluid communication with the channel of the die, and wherein an upstream side of the weld chamber is configured to couple to a downstream side of the fixture.

3. The apparatus of claim 2, wherein the weld chamber includes one or more windows on side thereof that communicate between an exterior side and an interior side of the weld chamber.

4. The apparatus of claim 1, wherein the fixture is integral with the weld chamber.

5. The apparatus of claim 1, wherein the die comprises a splitter, the splitter including one or more webs that define two or more channels.

6. The apparatus of claim 5, wherein the splitter is disposed on an upstream side of the die.

7. The apparatus of claim 5, wherein the splitter includes a center obstruction and a peripheral ring, and wherein the one or more webs radially extend from the center obstruction to the peripheral ring.

8. The apparatus of claim 1, wherein the chamber is comprised of a first housing and a second housing, and wherein the first housing is upstream of the second housing.

9. The apparatus of claim 8, wherein the chamber further comprises a plug configured to be received at least by the first housing.

10. The apparatus of claim 9, wherein a downstream side of the plug includes an indent that corresponds in shape to the material.

11. The apparatus of claim 9, wherein:
the chamber further comprises a sleeve that is annular;
an exterior surface of the sleeve corresponds to an interior surface of the second housing; and
an interior surface of the sleeve defines the opening of the chamber.

12. The apparatus of claim , wherein the material is selected from a metal, a polymer, and combinations thereof.

13. A apparatus for extruding a material, comprising:
a chamber that includes an opening that faces at least a downstream side of the chamber for receiving the material in an original state, the chamber including:
a first housing and a second housing disposed downstream of the first chamber,
a plug configured to be received at least by the first housing,
a sleeve that is annular and configured to move axially at least within the second chamber, and
a clamp for coupling the first chamber and the second chamber;
a die that is downstream and slideably received by the opening of the chamber;
a base portion that includes a fixture, the fixture being annular and configured to couple to a downstream side of the die; and
a channel that continuously extends from the opening of the chamber and through the die and the fixture.

14. The apparatus of claim 13, wherein an upstream side of the die includes a surface that slopes in the direction of the channel.

15. A method for extruding a material, comprising:
providing an apparatus that includes:
a chamber that includes an opening that faces at least a downstream side of the chamber, the opening having a size corresponding to the material in an original state,
a die downstream of the chamber that is slideably received by the opening of the chamber, the die including a channel that is in fluid communication with the opening of the chamber, and
a base portion that includes a fixture, the fixture being annular and configured to couple to a downstream side of the die;
placing a material in an original state within the opening of the chamber and upstream of the die;
applying a force to an upstream side of the chamber to thereby push the material through the channel of the die; and
collecting the material in a modified state downstream of the fixture.

16. The method of claim 15, further comprising, before the applying step, thermally soaking the material in the original state to a soaking temperature corresponding to about 50% to about 99% of a melting temperature of the material.

17. The method of claim 16, wherein the soaking temperature corresponding to about 70% to about 90% of the melting temperature of the material.

18. The method of claim 16, wherein the thermal soaking step is about 0.5 hours to about 3.0 hours in duration.

19. The method of claim 15, wherein a longitudinal axis of the apparatus is oriented in an vertical position.

20. The method of claim 15, wherein the chamber further includes:
a plug configured to be received at least by the first housing, and
a sleeve that is annular and configured to move axially at least within the second chamber.
